(19) United States
(12) Patent Application Publication
(10) Pub. No.: US 2005/0189275 A1
(43) Pub. Date: Sep. 1, 2005

(54) Liquid level sensor with odor reduction for waste holding tanks

(76) Inventor: Glen Harris Stewart, Ellicott City, MD (US)

Correspondence Address: Mr. Glen Stewart, P.O. Box 123, Glenelg, MD, 21737-0123, US

(21) Appl. No.: 10/790,384

(22) Filed: Mar. 1, 2004

(51) Int. Cl. C02F 1/74

(52) U.S. Cl. 210/86; 210/220; 210/90; 73/299; 73/866.5

(57) ABSTRACT

A sensor for determining liquid level while reducing odor for use in a marine vessel or RV waste holding tank. The sensor includes an aeration tube and a pressure sensor. The aeration tube is disposed in a bottom portion of the holding tank. An aeration pump is in fluid communication with the aeration tube and the pressure sensor and supplies pressurized air to the aeration tube. The aeration tube is disposed in a bottom-most portion of the holding tank and is submerged in sewage. The pressure in the aeration tube is measured by the pressure sensor and the pressure is correlated to liquid level in the waste holding tank. Pressurized air from the aeration pump is injected into the sewage via the aeration tube and creates an oxygen-enriched aerobic environment therein. Air from the holding tank is continuously vented to atmosphere via a vent in the tank.

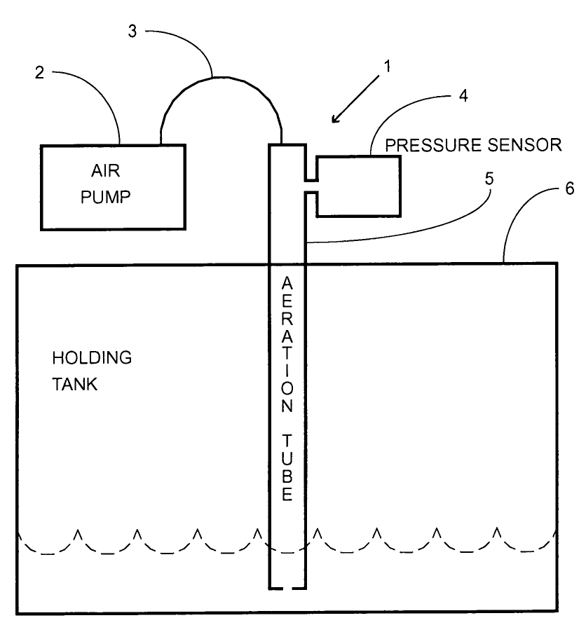

### BACKGROUND OF THE INVENTION

1. Field of the Invention

The present invention generally pertains to marine and recreational vehicle (RV) waste holding tanks and, more particularly, combining in a single apparatus level sensing and odor reduction for such waste holding tanks.

2. Description of Related Art

Waste from toilets aboard marine vessels and recreational vehicles is generally flushed by the toilet system into a holding tank where it is held for treatment, or for disposal into a land-based sewage handling system. For safety reasons, the holding tank is always vented to atmosphere. As a result, each time additional sewage is flushed into the holding tank, air within the holding tank is displaced by incoming sewage, forcing foul-smelling air out the vent. The holding tanks are also typically outfitted with a device for sensing the level of waste in the tank, to prevent overflow or back-up of sewage.

Traditionally, the devices for reduction of odor and for sensing level are embodied in seperate physical mechanisms. For example, U.S. patent application No.20030080055 employs a supply of air into the sewage in the holding tank to create an oxygen-enriched environment in the sewage, thereby assisting in reducing the odors emanating from the sewage within the holding tank.

Physical space is often limited in holding tanks, and having two devices which must be installed and maintained in the holding tank increases cost and can reduce reliability.

Therefore, there exists a need in the art for a device that can perform both functions of odor-reduction and level sensing in a single physical embodiment.

### SUMMARY OF THE INVENTION

The present invention is directed toward a device for sensing the level of sewage in a marine or RV waste holding tank, while simultaneously and in the same physical package reducing or eliminating the odors emitted from the holding tank.

In accordance with the present invention, a marine vessel or RV includes a waste holding tank, an aeration pump, an aeration tube, and a pressure sensor. The waste holding tank is installed within the marine vessel or RV and has the aeration tube disposed in the tank, as close to the tank bottom as possible. The output of the aeration pump and aeration tube is in fluid communication with the sewage in the holding tank, and in fluid communication with the pressure sensor, and is adapted for operation such that air is communicated to the aeration tube and the pressure sensor.

In further accordance with the present invention, the waste holding tank also includes an inlet for sewage, an outlet through which sewage is pumped out of the holding tank, and a vent. The vent is continuously opened, to expel air from the tank.

In further accordance with the present invention, a method for sensing the level of sewage in the holding tank is provided. The method includes:
a. installation of a pressure sensor at a point on the aeration tube; and,
b. supplying power to the pressure sensor for the purpose of providing an output signal correlated to holding tank sewage level.

In further accordance with the present invention, a method for reducing perceived odors emanating from a marine vessel or RV waste holding tank is provided. The method includes the steps of:
a. submerging an aeration tube in sewage substantially continuously;
b. supplying pressurized air to the aeration tube substantially continuously to thereby inject air into the sewage surrounding the aeration tube and to create an oxygen-enriched condition in the sewage; and,
c. gradually and continuously expelling air from the holding tank through the vent.

### BRIEF DESCRIPTION OF THE DRAWING

These and further features of the invention will be apparent with reference to the following description and drawing, wherein:

the drawing is a schematic illustration of the odor-reduction and level-sensing device according to the present invention.

In the illustrated embodiment, the pressure sensor 4 is arranged to one side of the aeration tube 5, with the air supply line 3 entering the top of aeration tube 5. It is considered apparent that the positions of the pressure sensor 4 and the air supply line 3 could be switched or otherwise arranged without changing the function of the sensor 1 or the system incorporating the sensor 1. Moreover, the pressure sensor 4 and the air supply line 3 can be of any shape or orientation. Moreover the aeration tube 5 can be of any shape.

The sensor 1 is comprised of the aeration tube 5 which is in fluid communication with the sewage in the holding tank 6, the pressure sensor 4 and the air supply line 3. The air supply line 3 is likewise in fluid communication with the air pump 2.

The sensor 1 of the present invention has one end open as close to the bottom of the holding tank 6 as possible. The operation of the air pump 2 supplies air via the air supply line 3. This causes air to flow through the aeration tube 5into the sewage in the holding tank 6. The amount of back pressure generated in the aeration tube 5 will correlate to the level of sewage in the holding tank 6. The pressure sensor 4 will measure this back pressure and will provide an output signal that correlates to the level of sewage in the holding tank 6.

Although various means of air-tight mechanical attachment may be employed, the sensor 1 preferably has a hose barb or nipple compatible with the air supply line 3 in use. In any event, the sensor 1 will sealingly engage the air line used to connect to air supply line 3.

Although various means of air-tight mechanical attachment may be employed, the sensor 1 will install sealingly in the holding tank 6.

The present invention has been described herein with particularity, but it is noted that the scope of the invention is not limited thereto. Rather, the present invention is considered to be possible of numerous modifications, alterations, and combinations of parts and, therefore, is only defined by the claims appended hereto.

1. A sensor for use in detecting the level of liquid in a waste holding tank, comprising: a pressure sensor, an aeration tube, and a supply of air, said pressure sensor being disposed on the aeration tube; said aeration tube being disposed in a holding tank, with one end outside the tank and connected to an air supply tube connected to an air pump, the other end of the aeration tube being disposed inside the holding tank as close to the bottom of the holding tank as possible; said supply of air being substantially continuously supplied via an air supply tube connected to an air pump, wherein: measurement of air pressure in said aeration tube, using said pressure sensor, is used to determine liquid level in said holding tank.

2. The sensor according to claim 1, wherein said pressure sensor and aeration tube are sealingly connected to one another.

3. The sensor according to claim 1, wherein the substantially continuous supply of air into said aeration tube in said holding tank provides air to said sewage to create an oxygen-enriched environment in said sewage, thereby assisting in reducing the odors emanating from said sewage within said holding tank.
